(19) United States
(12) Patent Application Publication
(10) Pub. No.: US 2005/0109761 A1
(43) Pub. Date: May 26, 2005

(54) Portable, self-heating cooking utensil

(76) Inventors: Arlethia Little, North Chicago, IL (US); Mary Ann Little, North Chicago, IL (US)

Correspondence Address: DAVID P. GAVDIO, 332 ACADEMY ST, CARNEGIE, PA, 15106, US

(21) Appl. No.: 10/719,545

(22) Filed: Nov. 24, 2003

(51) Int. Cl. F27D 11/00

(52) U.S. Cl. 219/438

(57) ABSTRACT

A battery powered cooking utensil includes a concave body with a bottom portion and an upwardly extending sidewall. It also has a handle attached to and projecting from the sidewall of the concave body; the handle including an internal compartment for containing therein at least one battery. A removably securable cap is provided for closing the internal compartment and sealing from the external environment any batteries placed within the internal compartment. A plurality of coils are embedded within the concave body, and these form an electrical circuit with the batteries whereby heat is generated in the coils to cook food placed within the body of the utensil.

### FIELD OF THE INVENTION

The present invention pertains to cooking utensils, and, more particularly, pertains to a portable, self-heating cooking utensil for both indoor and outdoor use.

### BACKGROUND OF THE INVENTION

In order to cook food in residential, commercial, and recreational settings contemporary society is dependent upon a continuous and readily available supply of gas and electricity. As long as this energy supply is continual and uninterrupted the preparation and consumption of food is a generally ordinary and uneventful process. However, should there be any interruption in the supply of gas or electricity to heat and prepare food, most members of today's society have little recourse but to await the resumption of the heat supply by the utility providers before any substantial preparation and cooking of food can occur. Only a small number of households have access to or use of wood burning stoves. Thus, such interruptions in the supply of electrical or gas heat can impose severe inconvenience on the affected residents.

Such interruptions can be the result of natural disasters, such as tornadoes, hurricanes, and earthquakes, failures or breakdowns in the energy grid system, or the inadvertent severing of electrical lines or gas pipes during construction projects.

In addition, there are many other situations and occasions that require or involve the preparation and cooking of food, and where either gas or electricity are difficult to obtain or simply unavailable. Such situations can include picnics, camping and outdoor activities, such as hunting, fishing, rock climbing, hiking or white water rafting.

All of the aforementioned situations will involve at some point the cooking and consumption of food; and yet access to electrical outlets or gas heating will be unlikely, if non-existent. In view of the above-described problems, a number of devices have been conceived that allow food to be cooked in situations where access to gas and electrical supplies is limited or non-existent, or that provide for a more efficient heating and cooking of the food.

For example, the Shevlin patent (U.S. Pat. No. 3,505,498) discloses a cooking utensil having a cooking receptacle that is insulated from the heating element by a dielectric layer comprised essentially of a vitreous porcelain composition. However, the Shevlin utensil requires an external heating source.

The Kuhlman patent (U.S. Pat. No. 5,873,300) discloses a device for heating food evenly and efficiently, and the device includes a base, a lid, a heat conductive element resting on the base, and a heat distributive shield affxed to the opposite surface of the heat conductive element. The Kuhlman apparatus is heated by various types of heat sources such as candles.

The Hicks design patent (U.S. Pat. No. D391,803) merely discloses a suggested design for a battery powered cooking pot but does not disclose any details pertaining to the location of the battery or the methods for controlling the heat source.

The Hu patent (U.S. Pat. No. 5,129,314) discloses an electric wok having a receiving space at the pan bottom wherein several induction coils for heating food are disposed; but the induction coils are connected to an external power source.

The Rhear patent (U.S. Pat. No. 4,332,188) discloses a combination cooker having a heating element disposed in the lower portion of the base of the body of the cooker, but the heating element must be heated from an external power source, i.e., an electrical outlet.

Therefore, despite the ingenuity of the above devices, there is a need for a cooking apparatus that can heat and cook food by an internal or self-contained heating element or source in all types of weather and both indoors and outdoors.

### INTRODUCTION TO THE INVENTION

The present invention comprehends a portable cooking utensil that includes a self-contained internal heating element with the cooking utensil preferably being a skillet or pot. The cooking utensil includes a concave body with a flat exterior bottom portion. Attached to the body of the cooking utensil, is an elongated handle. The handle includes an internal compartment that is closed by a removable cap. The compartment is sized to receive at least one battery. In the presently preferred embodiment, the internal compartment is sized to receive three D-cells. The batteries are in electrical connection with heating coils disposed within the bottom portion of the cooking utensil for providing the necessary heat to cook the food placed within the utensil. The batteries and heating coil are, preferably, controlled by an on-off switch mounted on the handle.

Regarding feasibility, it is noted that one D-cell is reported to provide 18 Ampere-hours at 1.5 Volts. This is 97,200 Joules, or 23,200 calories. One D-cell would provide enough energy to heat 290 grams of water from 20 degrees C. to the boiling point. Three cells would heat 870 grams of water to the boiling point. Thus, the invention appears to supply sufficient energy for cooking, without involving large amounts of power which could be hazardous if employed by a child or an adult having diminished abilities.

It is an objective of the present invention to provide a portable, self-heating cooking utensil that is able to heat and cook food without the need of gas, electricity from utility companies, or fire as the heat source.

It is another objective of the present invention to provide a portable, self-heating cooking utensil that can be used both indoors and outdoors and does not pose a fire risk during use.

It is still yet another objective of the present invention to provide a portable, self heating cooking utensil that is lightweight and can be used by campers, outdoorsmen, picnickers, and travelers.

Yet another objective of the present invention is to provide a portable, self heating cooking utensil that can be used in all weather conditions throughout the entire year.

A further objective of the present invention is to provide a cooking utensil that can be employed by children which does not expose the children to dangerous voltages.

These and other objects, features, and advantages will be manifest to one skilled in the art upon a perusal of the following detailed description and the accompanying drawings.

### SUMMARY OF THE INVENTION

The present invention is a cooking utensil for cooking food. The utensil includes a concave body with a bottom portion and an upwardly extending sidewall. It also has a handle attached to and projecting from the sidewall of the concave body; the handle including an internal compartment for containing therein at least one battery. A removably securable cap is provided for closing the internal compartment and sealing from the external environment any batteries placed within the internal compartment. A plurality of coils are embedded within the concave body, and these form an electrical circuit with the batteries whereby heat is generated in the coils to cook food placed within the body of the utensil.

### BRIEF DESCRIPTION OF THE DRAWINGS

FIG. 1 is a perspective view of the portable, self-heating cooking utensil of the present invention illustrating the embodiment of the invention in the form of a skillet;

FIG. 2 is a perspective view of the portable, self-heating cooking utensil of the present invention illustrating the embodiment of the invention in the form of a pot;

FIG. 3 is a sectioned elevational view of the handle of the skillet taken along lines 3-3 of FIG. 1;

FIG. 4 is a sectioned elevational view of the concave-shaped body of the cooking pot taken along lines 4-4 of FIG. 2; and

FIG. 5 is a top plan view of the handle of the cooking utensil illustrated in FIGS. 2 and 4 showing the on/off switch for controlling the heating features and elements disposed within the utensil.

### IDENTIFYING NUMERALS EMPLOYED IN THE DRAWINGS

10 Skillet
12 Body of skillet
14 Sidewall of skillet
16 Bottom portion of skillet
18 Handle of skillet
20 Interior flat cooking surface
24 Lid
26 Cap on handle
30 Cooking pot
32 Body of cooking pot
34 Sidewall of cooking pot
36 Bottom portion of cooking pot
38 Handle of cooking pot
40 Interior cooking surface of cooking pot
42 Underside of cooking pot
44 Lid of cooking pot
46 Cap on handle of cooking pot
54 Chamber for battery or batteries
56 Batteries
58 Contact plate
60 First conductor
62 Second conductor
64 Coils
66 On off switch
68 Medium button
70 High button

### DETAILED DESCRIPTION OF THE PRESENTLY PREFERRED EMBODIMENTS OF THE PRESENT INVENTION

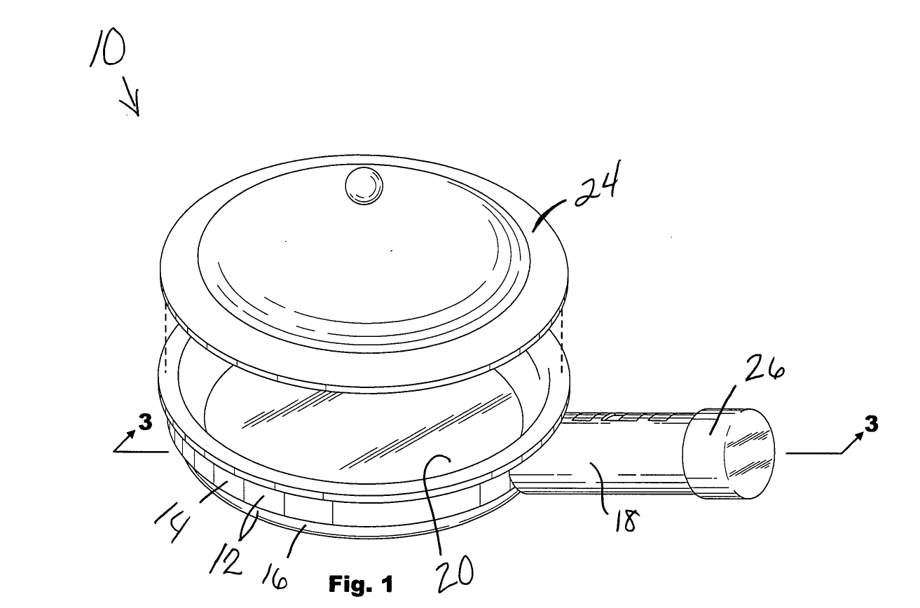

Illustrated in FIGS. 1 through 5 are embodiments of a lightweight, all-weather, indoor and outdoor, portable cooking utensil including internal and self-contained heating features and elements that allow food to be cooked without requiring the use of gas or an electrical supply outlet.

The embodiment of the invention illustrated in FIG. 1 is in the form of a skillet, generally designated 10. The skillet 10 includes a low profile, concave body 12 including an annular sidewall 14 and a flat bottom portion 16. An elongated handle 18 is attached to body 12.

The flat bottom portion 16 of the body 12 of the skillet 10 is further defined by an interior flat cooking surface 20. A lid 24 is sized to fit on the body 12 of the skillet 10 and seal the concave body 12 from the external environment during food preparation and cooking. The handle 18 has a removably securable screw-on or snap-on cap 26. Preferably, cap 26 is sealed against handle 18 to prevent entry of moisture into handle 18.

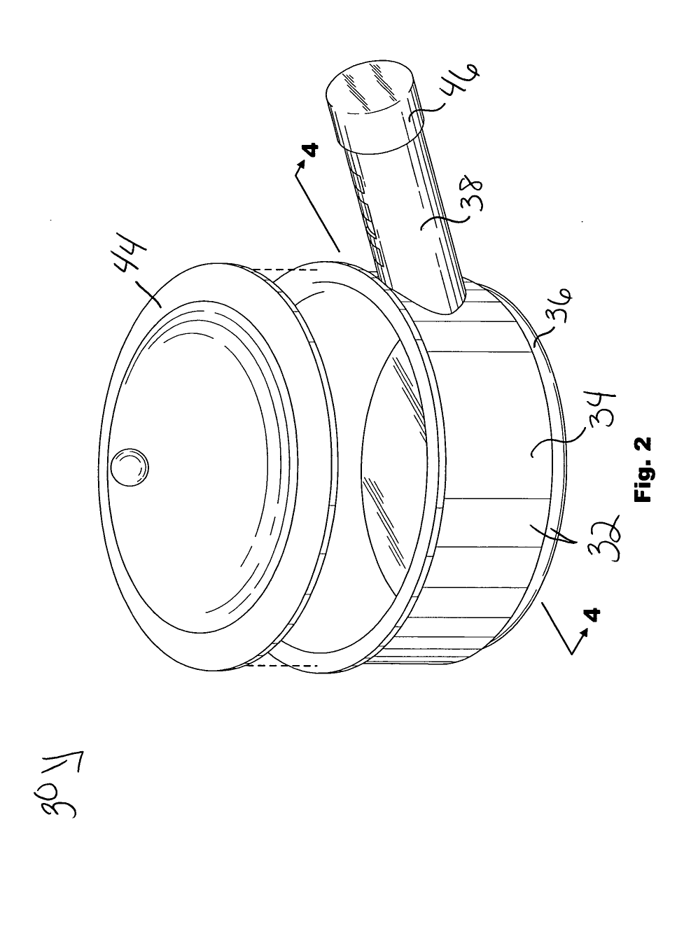

The embodiment of the invention illustrated in FIG. 2 is in the form of a cooking pot, generally designated 30. The pot 30 includes a deeper profile concave body 32 including an annular sidewall 34 and a bottom portion 36. An elongated handle 38 is attached to body 32. The bottom portion 36 of the body 32 of the pot 30 is further defined by an interior cooking surface 40 and an opposite underside 42, best seen in FIG. 4. Preferably, underside 42 is flat. A lid 44 is sized to fit on and cover the pot 30 and seal the concave-shaped body 32 from the external environment during food preparation and cooking. In addition, the handle 38 has a removably securable screw-on or snap-on cap 46. Preferably, cap 46 is sealed against handle 38 to prevent entry of moisture into handle 38. Preferably, handle 38 extends upwardly from sidewall 34.

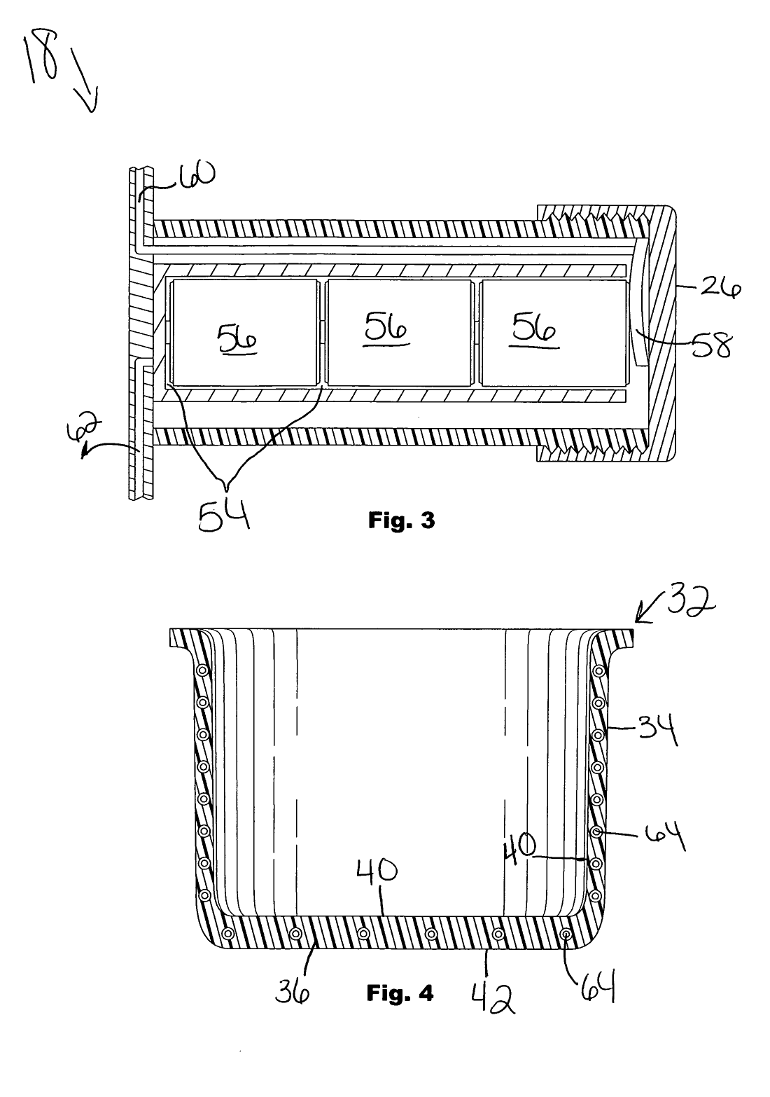

FIG. 3 is a sectioned elevational view of the handle 18 of the skillet 10 taken along lines 3-3 of FIG. 1. Preferably, the handle 38 of cooking pot 30 is similar to the handle 18 of the skillet 10. FIG. 3 illustrates chamber 54 for one or more batteries 56. Preferably, chamber 54 is sized to receive three D-cells. Preferably, chamber 54 is sealed off from the environment by cap 26. A contact plate 58 on the inside of cap 26 connects battery 56 to first conductor 60. A second contact plate (not shown) is attached to second conductor 62 to complete the electrical circuit.

FIG. 4 is a sectioned elevational view of the concave-shaped body of the cooking pot 30 taken along lines 4-4 of FIG. 2. Heating coils 64 are disposed in bottom 36 of cooking pot 30. Preferably, heating coils 64 are also disposed in sidewall 34 of cooking pot 30. Coils in skillet 10 are similar, but, preferably, disposed only in bottom portion 16 of skillet 10.

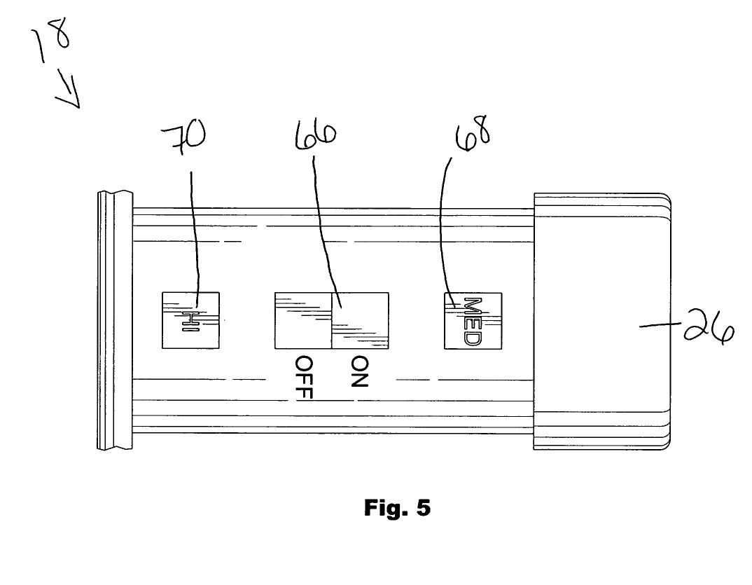

As shown in FIG. 5, the handle 18 includes an on off switch 66, and for further control of the heating and cooking of the food, both medium 68 and high 70 buttons are included. A person skilled in the art will recognize that a choice of heat settings may be accomplished by including two alternatively selectable coils 64, or by connecting different numbers of batteries 56 to a single coil 64.

As shown in FIGS. 4 and 5, the batteries 56 supply energy to a plurality of coils 64 embedded within the body 32, preferably, in both the sidewall 34 and bottom portion 36 of the pot 30. As the coils 64 heat up, the heat is conducted through the body 32 of the pot 30 to the food whereupon the food is heated and cooked. The number and spacing of the coils 64 can vary according to the dimensions of the particular cooking vessel, and it is conceivable to employ a longer handle for certain cooking vessels that would accommodate more than three batteries. The batteries 56, electrical conductors 60 and 62, and the coils 64 are enclosed within the body 28 of the cooking pot 30 and/or the handle 38 and are thus protected from damage due to water or moisture infiltrating therein. The skillet 10 shown in FIG. 1 would also include substantially the same elements and features as set forth for the cooking pot 30. Moreover, both the skillet 10 and cooking pot 30 embodiments of the present invention may come with a battery charger for recharging spent batteries, and an adapter may be provided for recharging through the cigarette lighter found in automotive vehicles.

The foregoing description discloses and describes several embodiments for the invention, and those skilled in the art will understand that other variations and modifications are possible and practicable, and still come within the ambit of the invention.

1-11. (canceled)

12. A cooking utensil for cooking food, comprising:
a concave body having a flat bottom portion and an upwardly extending sidewall;
a handle attached to and projecting from the sidewall of the concave body;
the handle including an internal compartment for containing therein at least one battery;
a removably securable cap for closing the internal compartment and sealing the batteries from the external environment;
an on/off switch mounted to the handle for controlling battery energy discharge;
a plurality of coils embedded within the concave body and forming an electrical circuit with the batteries so that the heat is generated in the coils when the switch is turned on thereby causing any food placed within the body and on the bottom portion to be cooked through heat generated in the coils; and
the food capable of being heated and cooked when the cooking utensil is in a level disposition or a non-level disposition.

13. A cooking utensil for cooking food, comprising:
a concave body having a flat bottom portion and an upwardly extending sidewall;
a handle attached to and upwardly projecting from the sidewall of the concave body;
the handle including an internal compartment for containing three D-cell batteries;
a removably securable cap for closing the internal compartment and sealing the batteries from the external environment;
an on/off switch mounted to the handle for controlling battery energy discharge;
a plurality of coils embedded within the concave body and forming an electrical circuit with the batteries so that heat is generated in the coils when the switch is turned on thereby causing any food placed within the concave body and on the bottom portion to be cooked by the heat generated in the coils;
a high button located on the handle for cooking the food with high heat;
a medium button located on the handle for cooking the food with medium heat; and
the food capable of being cooked within the concave body and on the bottom portion of the body when the cooking utensil is in a level disposition and in a non-level disposition.
